(19) United States
(12) Patent Application Publication
(10) Pub. No.: US 2005/0289040 A1
(43) Pub. Date: Dec. 29, 2005

(54) System and method of internet auctioning of goods dropped off by the general public or selected for liquidation at public storage facilities

(75) Inventors: Douglas L. Lecker, Tempe, AZ (US); Steven J. McGrady, Tempe, AZ (US); John Magni, Tempe, AZ (US)

Correspondence Address: Donald R. Greene, P.O. Box 12995, Scottsdale, AZ, 85267-2995, US

(73) Assignee: Encompass Ventures LP, Scottsdale, AZ (US)

(21) Appl. No.: 10/869,796

(22) Filed: Jun. 15, 2004

(51) Int. Cl. G06F 17/60

(52) U.S. Cl. 705/37

(57) ABSTRACT

A method and system for processing goods for auction by an online auction provider includes providing a multiplicity of sites within a designated limited geographical area for customer drop-off of goods desired to be sold at online auction, wherein the sites consist of a plurality of pre-existing free-standing multi-unit public storage facilities in the designated geographical area available to the general public for individual unit monthly rental; processing the dropped-off goods to assess their suitability for online auction; and uniquely identifying each of the acceptable dropped-off goods for placement in a queue for auction by the online auction provider. The uniquely identified dropped-off goods are relocated to a central location for placement in the auction queue of the online auction provider.

### BACKGROUND OF THE INVENTION

A. Field of the Invention

The present invention relates generally to Internet auctions, and more specifically to the Internet auctioning of goods facilitated by drop-off at specified storage facilities by members of the public at large for sale by auction or selected for liquidation by auction. Processing of the dropped-off goods is performed at the respective drop-off site to assess acceptability of the goods for online auction.

B. Prior Art

In general, auctions on the Internet are performed by a broker (house conducting the auction) who posts the offering of goods to be sold on the Internet by a willing seller to the highest bidder in an auction conducted over a set period of time, with or without reserve. Typically, the seller posts the whereabouts of the goods and it is the responsibility of prospective buyers to verify the representations made by the seller respecting the goods, usually with a disclaimer of liability in favor of the broker. The broker takes a percentage of the payment made by the successful bidder in return for the brokerage services.

To facilitate the auction process, it has been the practice in the typical Internet auction that the broker makes available or contracts with others for facilities for storage of the goods to be sold at auction, these facilities generally comprising medium to large warehouses strategically placed in various cities around the country. The cost of construction or leasing of these warehouses can be prohibitive. Furthermore, the locations of the warehouses may be inconvenient to many prospective customers. Moreover, many individuals who possess goods particularly suitable for marketing by online auction are unfamiliar with the process or are put-off by its lack of convenience.

### SUMMARY OF THE INVENTION

It is a principal object of the present invention to provide a method of processing goods for auction by an online auction house that offers considerably greater information and convenience to prospective sellers of goods (customers of the broker or service provider), and substantially lower cost to the service provider, than have heretofore been available by state of the art methods.

According to the present invention, a method of processing goods for auction by an online auction house comprises providing a multiplicity of sites within a designated limited geographical area for customer drop-off of goods desired to be sold at online auction, wherein the sites consist of a plurality of pre-existing free-standing multi-unit public storage facilities in the designated geographical area available to the general public for individual unit monthly rental; processing the dropped-off goods to assess their acceptability for online auction; and uniquely identifying each of the accepted dropped-off goods for placement in a queue for auction by the online auction house. The uniquely identified dropped-off goods are then removed to a designated central location in the designated geographical area for placement in the auction queue.

As an adjunct to the method of the invention, goods designated by the storage facility for liquidation from foreclosed third party units at the storage facility site, because of non-payment of rent or other breach of the storage facility agreement by the third party renter, may be processed to assess their acceptability for online auction. Each of the accepted liquidation goods would then be uniquely identified at the storage facility, and, after removal to a designated central location in the designated geographical area along with the uniquely identified dropped-off goods from that site, placed in the auction queue.

### BRIEF DESCRIPTION OF THE DRAWINGS

The above and still further objects, aspects, features and attendant advantages of the present invention will become more apparent from a consideration of the following detailed description of certain preferred methods of the invention constituting the presently contemplated best mode of practicing the invention, taken in conjunction with the accompanying figures of drawing, in which:

FIG. 1 is a block flow diagram of the method of Internet auctioning of goods dropped off by the general public or selected for liquidation at storage facilities of the present invention;

FIG. 2 is a block flow diagram of the storage facility set-up process of the present invention;

FIG. 3 is a block flow diagram of the method of liquidating items from a storage unit located at a storage location in one embodiment of the present invention.

FIG. 4 is a block flow diagram of the method of a customer dropping off an item for the auction service in the process of the present invention;

FIG. 5 is a block flow diagram of the method of identifying, retrieving and transporting items to a centralized fulfillment center in an embodiment of the present invention;

FIG. 6 is a block flow diagram of the process for receiving items into the central fulfillment center of the present invention;

FIG. 7 is a block flow diagram of the process for item auction preparation of the present invention;

FIG. 8 is a block flow diagram of the process for billing, payment collection and shipping of items as an embodiment of the present invention;

FIG. 9 is a block flow diagram of the process of disbursing recognized revenue in an embodiment of the present invention;

FIG. 10 is a block flow diagram of the method of donating items not sold on the online auction provider web site as one embodiment of the present invention;

FIG. 11 is a flow diagram is a flow diagram illustrating the manner in which exceptions report items are handled; and

FIG. 12 is block diagram of the system of the invention.

### DETAILED DESCRIPTION OF THE PRESENTLY PREFERRED METHODS

It is estimated that current online consumer and business auction transactions have an annual market size exceeding 1.9 trillion. The Internet's largest auction site, eBay™, registered 2003 sales in excess of $2.2 billion. And online auctions in 2004 are running at a rate several times that of the comparable period of 2003. Nevertheless, a segment of the total available market is not presently served on the Internet, namely, individuals who wish to dispose of items of property but lack knowledge of the way that such items may be sold through online auctions. Accordingly, an ancillary services market has evolved to provide guidance and other services to unsophisticated sellers who desire to auction their items on eBay, for example, through a local drop-off center. The service center allows the general public to drop off items to be offered for sale through an Internet (online) auction house, such as eBay, and, in return for a fee paid to the service center provider (or simply, “service provider”), to receive expert auction assistance from the provider, including developing the eBay listing; photographing, packaging and shipping the item; and processing all payments made by seller and buyer to initiate and achieve a successful auction outcome. At the conclusion of the successful auction, the seller receives payment by mail, less commission to the online auction house and any then-unpaid fee to the service provider. Estimates by eBay place gross retail sales for this segment at $20-$25 billion, with the unrelated (to the auction house) service provider's commissions averaging approximately 30%, or about $6-$7.5 billion.

The challenge in providing eBay auction drop-off and guidance center services is the provision of locally convenient locations. Most companies that enter this market initiate the process with from 1-5 customary storefronts within a metropolitan area. In contrast, the present invention enables the use of a considerably larger network of locally convenient services centers, without incurring construction or high dollar purchase or leasing costs, by accessing the currently available large numbers of public storage facility locations found in cities and town throughout the country. These locations are highly visible, relatively highly secure, and conveniently placed for availability to the general public. Currently, more than 37,000 free-standing multi-unit storage locations exist in the United States, with an average of roughly 5-6 such multi-unit storage facilities within a 5-mile radius in most major metropolitan areas. As used in this application, the terms “public storage,” “public storage facility,” “public storage unit,” and simply, “storage facility” and “storage unit,” shall be understood to mean any one or more free-standing multi-unit storage facilities where individual units are offered for rent to the general public for storage of goods, located in an incorporated or unincorporated municipality, in which one or more units of the facility are under contract or available to be contracted to a services center provider or other entity acting on behalf of such provider for storage of goods to be sold at auction through an Internet auction house such as eBay.

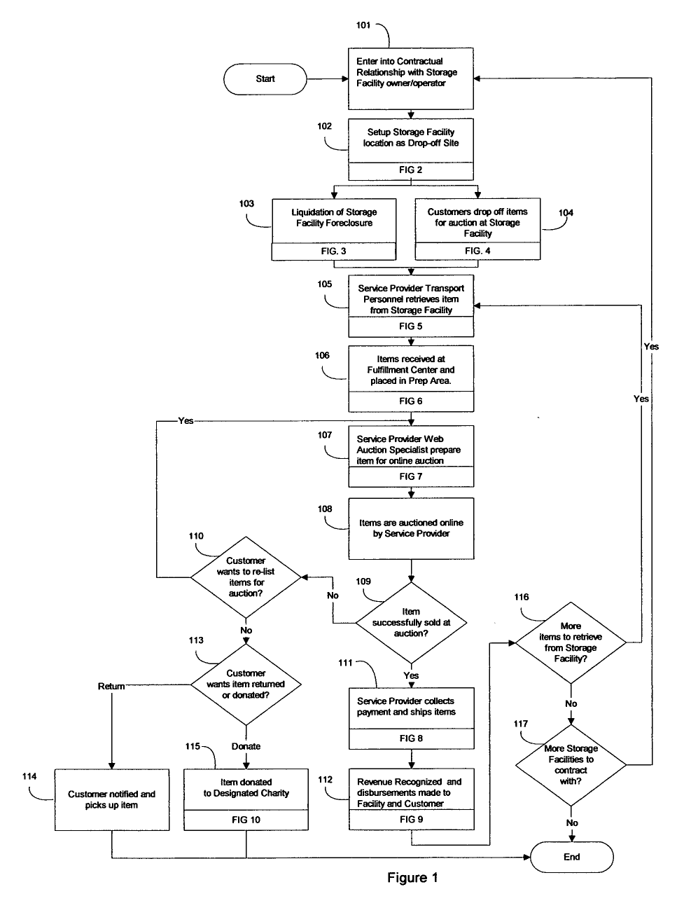

FIG. 1 is a flow diagram of a presently preferred method of Internet auctioning of goods dropped off by the general public or selected for liquidation at storage facilities according to the invention. In step 101, a service provider enters into a contractual relationship with a public storage facility owner or operator for storage of goods to be sold at auction over the Internet. The contractual relationship can be structured in many different ways. In a preferred arrangement, the service provider is not merely a commissioned agent representing the seller of the stored goods, but has control over disposition of the dropped-off goods inventory. The method of the present invention is differentiated from other consumer-to-consumer and drop-off Internet auction methods by, among other things, the use of existing public storage facilities as convenient locations at which prospective sellers of goods may drop-off their goods to the service provider's contracted units. Additionally, the method of the present invention may be utilized to offer a service currently not available to the public storage facility, by providing a more effective outlet for liquidating the contents of third party storage units that are foreclosed upon for non-payment of rental fees or other violation of the storage contract for which content liquidation is a lawful remedy (content liquidation units, and liquidation goods). To that end, the service provider may enter into a revenue sharing or other form of agreement with the storage facility owner, operator or management company regarding such attached goods. As with goods dropped off directly to public storage facility units contracted for by the service provider, the provider can promote the sale by online auction of the liquidation goods to attract the widest audience and return the highest value.

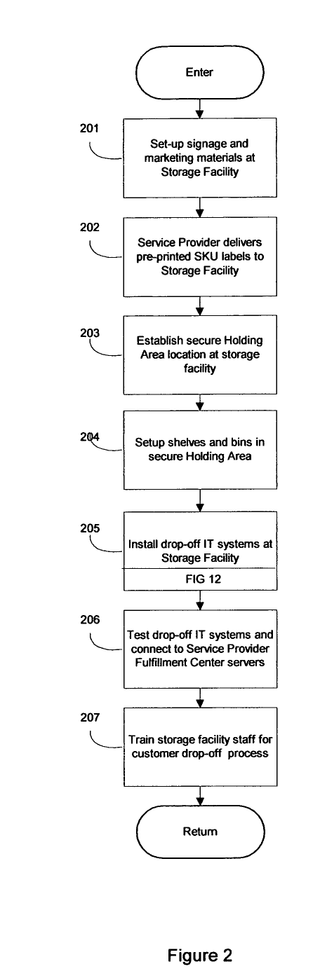

In step 102, a secure storage location is established for receiving, processing, and handling dropped-off items at the contracted public storage facility. As part of the installation, the service provider places signage and marketing materials (201, FIG. 2), establishes a secure holding area (203), sets up shelves and bins (204), installs a drop-off IT system (205), tests the IT system (206), and trains storage facility site personnel (207). Signage at the facility, in addition to on-site marketing materials and media advertising, acquaints the general public with the service provider, the provider's drop-off locations, and the services available in conjunction with the online auctioning of goods. A secure holding area with both climate-controlled and non-climate-controlled enclosures may be maintained by the service provider within the public storage facility to protect dropped-off goods initially, in contemplation of their entry into the auction process. Each holding area is preferably subdivided into sections with several bins and shelves to provide quick and convenient access for item storage and pick up. The IT computer system is used to input information on items in inventory at the respective public storage facilities, as well as all items added to and removed from inventory to maintain an up-to-date compilation of goods in the queue for the online auction process. Components of the IT system located at the public storage facility may include, among others: computer, a SKU (Stock-Keeping Unit) label printer (202), digital photographic camera, modem, and telephone. The IT storage facility computer system interfaces with the service provider's computerized Auction Management System (AMS) including accounts payable, general ledger, customer relationship management, and inventory management databases. Once the IT storage facility computer system is installed and tested, the service provider staff trains storage facility management and staff on how the system works, and procedures to familiarize the general public on use of the auction service.

Referring in somewhat greater detail to the flow diagram of FIG. 2, the service provider supplies the SKU bar code labels to its storage sites (202). The SKU labels may be generated in batch format at the service provider's central fulfillment center (discussed below) utilizing a third party application. Each different storage facility under contract is assigned a unique number that becomes part of the SKU bar code. For example, the first three digits of the bar code (e.g., alpha/numeric) may be used to represent the different public storage facilities at which the service provider has contract storage units and/or secure holding areas. The remaining characters of the bar code may be used to uniquely identify a respective individual item of goods to be sold at auction. An optional trailing character may serve as a checksum to confirm the validity of the SKU number. An exemplary format for the SKU number is “XXX-XXXXX-X”. Alternatively, the SKU bar code numbers and printed labels may be printed on demand at each individual storage facility from the storage facility computer.

A secure holding area, which may be one or more of storage units or separate from the individual units, may be used for temporary storage of the service provider's inventory of goods at the respective storage facility (203). Drop-off and liquidation goods are held there until pick-up by service provider transport personnel for delivery to the central fulfillment center for auctioning. Separate holding areas may be used for climate control or non-climate control depending on the nature of the goods to be stored therein. At a minimum, each holding area is secured under lock and key, accessible only to storage location management. This arrangement allows easy and convenient access to goods accepted for auction by service provider transport personnel pick-up through storage facility management personnel during normal (typically extended) business hours at the facility.

The service provider installs the IT system in the basic form of a computer connected to the Internet and to the service provider's fulfillment center (as well as to the fulfillment center database of current customers), at each storage facility (206). Additionally, the IT system includes an SKU bar code reader, printer, web camera and credit card processing system. All components of the IT system have interface capability to identify each item of goods to be auctioned, and to track the item throughout the auctioning process.

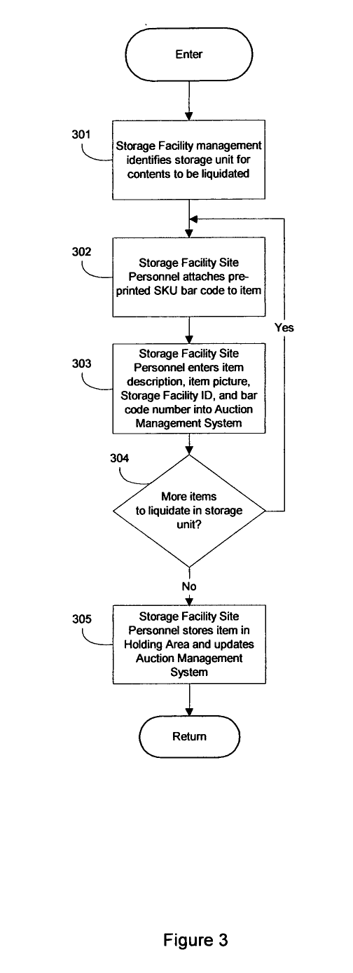

The storage facility may enter into a contract with the service provider to facilitate online auction sales of liquidation goods from content liquidation units (103, FIG. 1; 301, FIG. 3). Service provider Web Auction Specialists determine, from information supplied by storage facility site personnel, acceptability of the liquidation goods or any portion of them for auction. Storage facility personnel trained by the service provider photograph the goods for appraisal, place an SKU bar code on (SKU label) each, upload each item determined to be acceptable to the AMS for processing by service provider Web Auction Specialists (302, 303), and store them for pick up by service provider transport personnel (305).

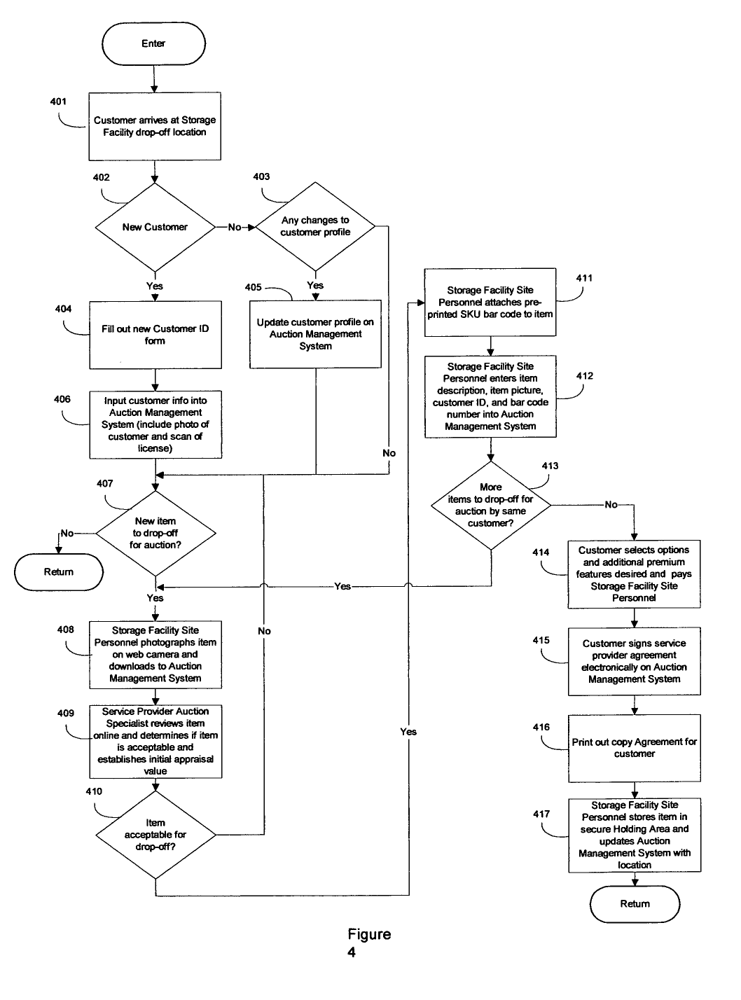

When a prospective customer visits the storage facility to drop off items for auction (104, FIG. 1; 401, FIG. 4), the customer is identified as existing or new (402), and in the former case, has any updated information added to the customer profile database (e.g., license number, mailing address, phone number, email address, historic auction item record, etc.) (403, 405), or in the latter case, has a complete customer profile inputted to the customer profile database storage facility site personnel, and in either case the customer profile is uploaded to the service provider's AMS (405, 406). Preferably, these duties are performed by the storage facility's on-site personnel under the contract with the service provider.

In addition to the advantage of the present invention of eliminating a need for the service provider to build, purchase or lease storefront-type locations for customer drop-off of goods to be auctioned online, the use of storage facility employees eliminates a need for the service provider to hire and place its own employees at each public storage site. Compensation to the owner or operator of the storage facility for these services to the service provider would, of course, take into account the time required of the storage facility's on-site personnel to perform these duties.

If a new item is being dropped-off for auction, it is photographed on web camera and downloaded to the AMS (407, 408). An inspection and appraisal of the item so identified is performed at the service provider's fulfillment center, and a determination as to whether the item is acceptable for potential sale through the auction service (409, 410). If additional information regarding the item is necessary before the determination of acceptability can be made, the auction specialist may obtain it from the storage facility staff. Upon acceptance of the item for auction, the auction specialist notifies the storage facility staff to place a preprinted SKU bar code on the item for unique identification thereof, have the customer complete the necessary forms of agreement and election options (e.g., minimum bid, any reserve, disposition of the item in the event of an unsuccessful auction, etc.), place the item in the secure holding area for pickup, and update the AMS (411-417).

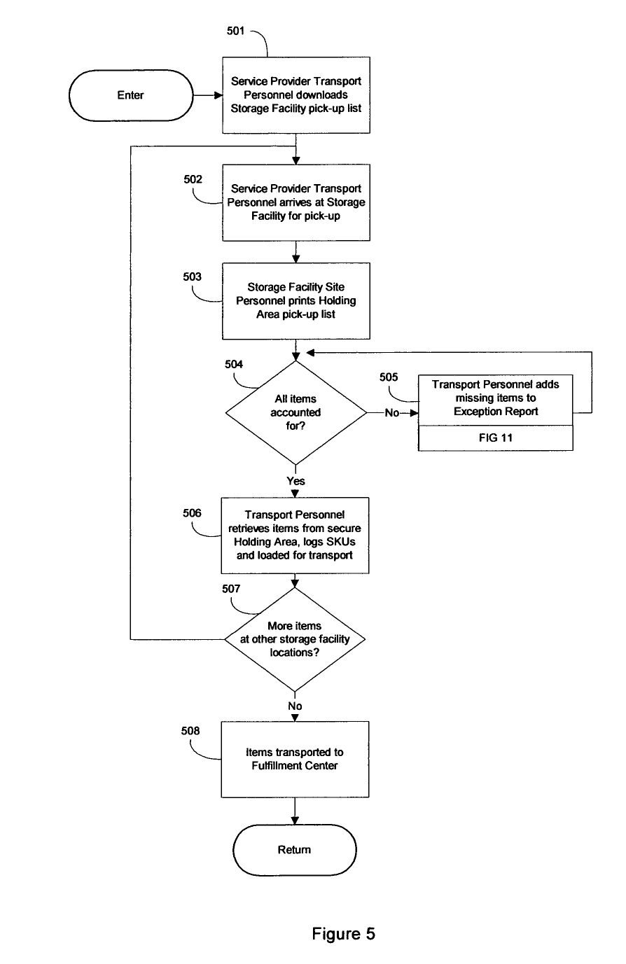

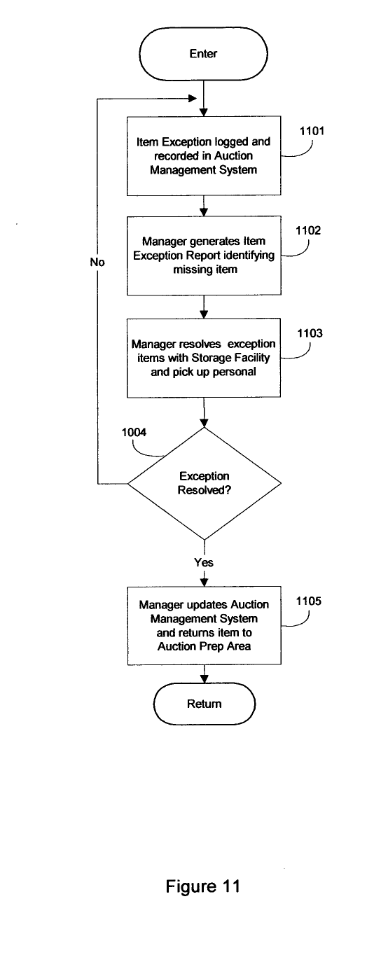

The service provider's transport personnel remove the accepted drop-off goods (as well as any accepted liquidation goods) from the secure holding area at storage facilities showing items ready for auction on a pick-up list generated by the AMS, to a central location (the service provider's fulfillment center) for any further processing and placement in the queue for auction by the selected online auction house (105, FIG. 1; 501-508, FIG. 5). A determination is made by the transport personnel that all items to be picked up are accounted for (504), and that any missing items are listed on an exceptions report (505; and FIG. 11), before leaving the storage facility. The collection of goods for online auction may be performed in regularly scheduled pick-up runs among the various storage facility sites in the designated geographical area, or may be made each time the AMS indicates a sufficient quantity of goods to be present in the secure holding area at a storage facility site, without advance scheduling.

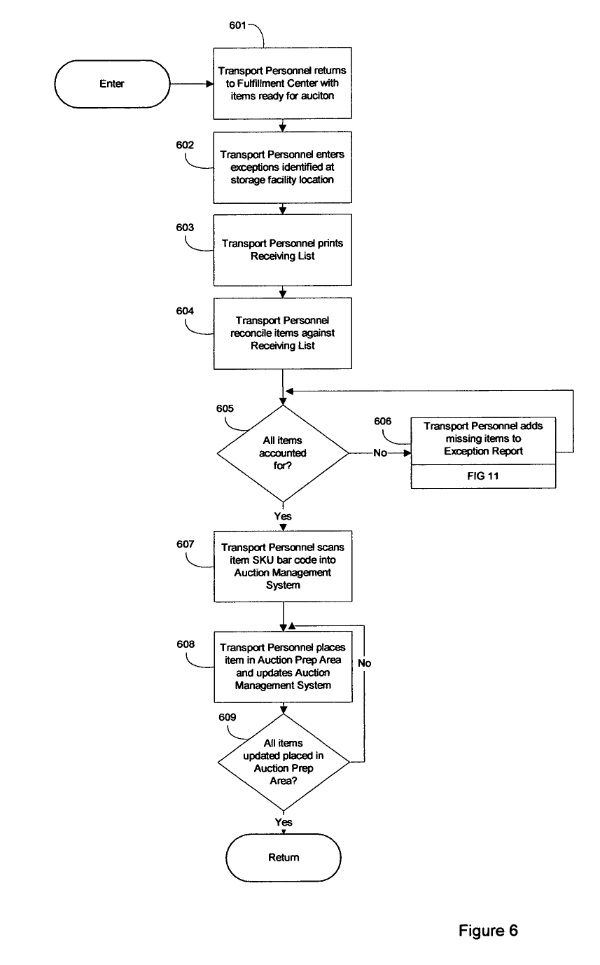

At the service provider's fulfillment center, the goods collected from the storage facilities are audited to determine that all items are accounted for or to identify any missing items, scanned by SKU label into the AMS for updating thereof and placed in an Auction Prep Area at the fulfillment center (106, FIG. 1; 601-609, FIG. 6).

Referring in greater detail to FIG. 6, when the transport personnel arrive at the fulfillment center, the retrieved items are unloaded (601), again compared to a receiving list, and any missing items entered in an exceptions report into the AMS (602-606). Entry of the exceptions report directly into the AMS is preferably accomplished via a wireless connection to the Internet from a hand-held portable device. Alternatively, the transport personnel uploads the item exception data through a hard-wire connection between a service provider owned central fulfillment center computer. Alternatively, the transport personnel may enter item exception data through a keyboard on a service provider owned central fulfillment center computer using the written records created in step 507 at a storage facility location.

The receiving list may be printed after a preliminary exceptions report is entered (602, 603), the items retrieved from the storage facilities then reconciled against the receiving list, and then a determination made whether all items expected to be received in the Auction Prep Area from this run are physically present (604, 605). At that juncture, any missing items are entered in a new item exception report into the AMS (606).

The items collected in the current run are scanned by identifying SKU bar code directly into the AMS, or alternatively, into an inventory database and then uploaded, either in batch or real-time, to the AMS (e.g., through a wireless connection) (607). Each item is then physically placed into the Auction Prep Area in a manner that allows for easy identification and retrieval of items using the SKU bar code as cross-reference to the physical location of the item. Alternatively, a separate location identification number may be assigned to each item as its SKU bar code is scanned into the AMS so that its physical location in the Auction Prep Area is identified in the AMS (608). A last check may be performed to assure that all of the collected goods from this run have been placed in the Auction Prep Area (609).

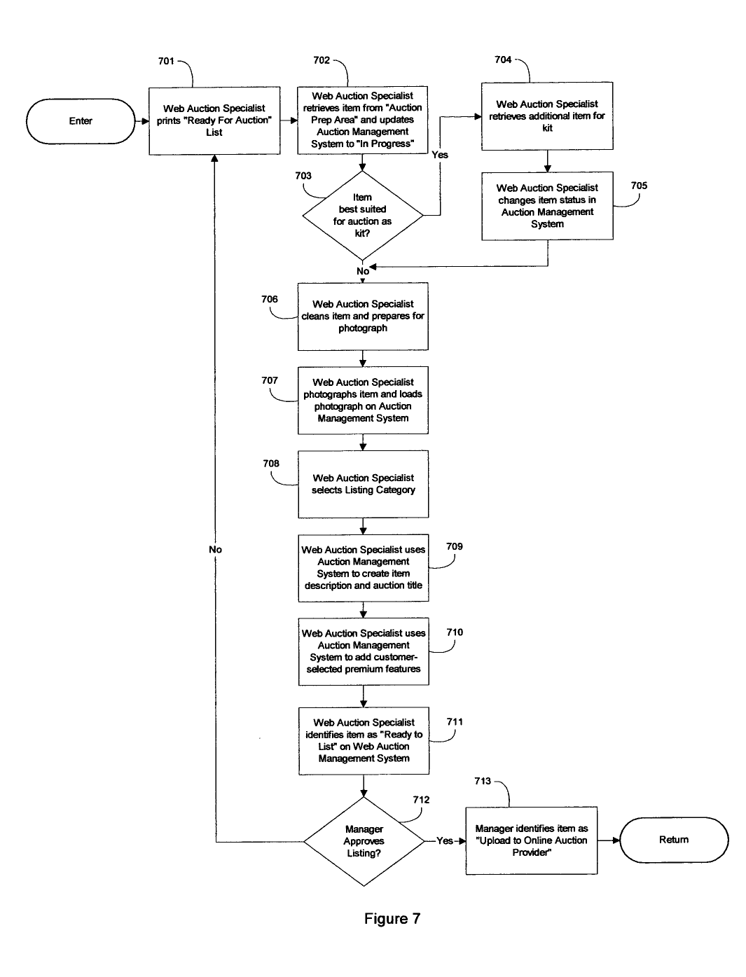

A service provider Web Auction Specialist reviews and prepares all items that have been uploaded to the AMS as “Ready for Auction” prior to posting them to the Internet auction web site (107, FIG. 1; 701-713, FIG. 7). The Web Auction Specialist may include one or more of the following before actual uploading each item to the online auction provider (e.g., eBay): set a bid category, enter up to three descriptions for each item, specify the type of auction, set an opening bid price, set a bid increment, set a bid reserve, set an auction length, specify shipping stipulation, and add comments to a notes field.

As illustrated in FIG. 7 at 701, the Web Auction Specialist reviews and updates all items that have been uploaded to the AMS as “Ready for Auction” prior to posting them to the Internet auction web site. To assist in the posting, the Web Auction Specialist may refer to previous winning bids for similar or related items as a further assessment of validity of current item pricing. The specialist starts by logging into the AMS and then accessing a “Ready for Auction” list on the AMS, i.e., a listing of all items posted to the AMS as “Ready for Auction” but not yet reviewed by a Web Auction Specialist. This listing would typically show items with the newest members listed at the bottom.

The specialist retrieves each item from the Auction Prep Area, updates the item as “In Progress” in the AMS (702), and inspects the item to determine whether its value may be enhanced by being combined with other individual items in a kitting process (703). The kitting process is best invoked for items that did not receive bids when listed individually. As a simple example, one item may be an unsold computer, another an unsold keyboard and/or a mouse, and yet another an unsold printer, which are readily combined for auction as a complete computer system package or “kit,” which is then described in that manner on the AMS as “Require Kitting” (704, 705).

Each item or kit is inspected, cleaned and prepared to be photographed for listing on an Internet Auction web site (706), .photographed preferably using a digital camera that plugs into a computer through a USB or Firewire port, with multiple pictures taken of each item in various positions, angles and proximities, to the extent reasonably necessary for its best showing, and the photographic files then stored in the AMS with identification by SKU of the respective item or kit (707).

The Web Auction Specialist then selects the appropriate listing category for auction of the item (708), preferably through a keyword search in the AMS or a third-party software application that lists relevant categories for the specific item or kit as defined by the online auction provider. Alternatively, the search may be conducted through a tree list of the categories on a software application that arranges the online auction provider's categories in a hierarchical structure where the first category is very generic and the fifth is quite specific, e.g., “Electronics and Photo” for Category One, “Photography” for Category Two, “Cameras” for Category Three, “35 mm SLR” for Category Four, and “Nikon™ 35 mm SLR” for Category Five, where the latter is the exact item to be auctioned.

After selecting an appropriate category, the specialist prepares a description of the item or kit (709), which may be the description entered by the storage facility site personnel including brand, condition, basic description, quantity and special information, updated with auction specific description data (which may, for example, be three descriptions, the first being short, of two or three words in length similar to the first category; the second much like the fourth level category title, perhaps up to ten words in length; and the third being very specific to the item, which may be very long. The Web Auction Specialist may also set the type of auction, such as English, Dutch, Buy it Now, and other variations; set the opening bid price (with reference to previously sales in the same category, the respective winning bid price, and the long description, and/or to numerous catalogs online, but otherwise, by default typically set at $1.00). Settings necessary for moving an item to the online auction provider's web site and taking the item live may be posted in other fields, including Go-Live date available (date the item is available to go live on the Internet auction web site); Go-Live open time (the time at which bidding on the item is allowed to start); minimum quantity (minimum number of identical items available for the auction under the listing); service provider shipping method (methods available for shipping the item (e.g., common carrier and pickup, or by default, UPS ground, UPS Second Day, USPS Priority Mail, and FedEx next day).

Premium services and features may be added by the specialist based on option elections made by the customer at drop-off of the item at a storage facility, including special bid increment, special bid reserve price, special auction length, special shipping stipulations, etc. (710).

When the item description is completed, the item is updated in the AMS as “Ready to List” (711). Preferably, the item is held in the “Ready to List” state until reviewed by a service provider manager who accesses a list of all items identified as “Ready to Auction” through a password-protected access page of the AMS. Upon manager approval of all items identified in the AMS as “Ready to List” (712), the status of each approved item is updated in the AMS as “Upload to Online Auction Provider” (713), which uploads items individually or in a batch process. If a special Go-Live date or time are set, the AMS holds the item and uploads it at that time.

If the item is not approved as ready to upload to the online auction provider, the service provider manager makes notes in the item's review field on the AMS, which subsequently updates the status of the item to “Ready for Auction” and a return to step 701 for a repeat of the process portion of FIG. 7.

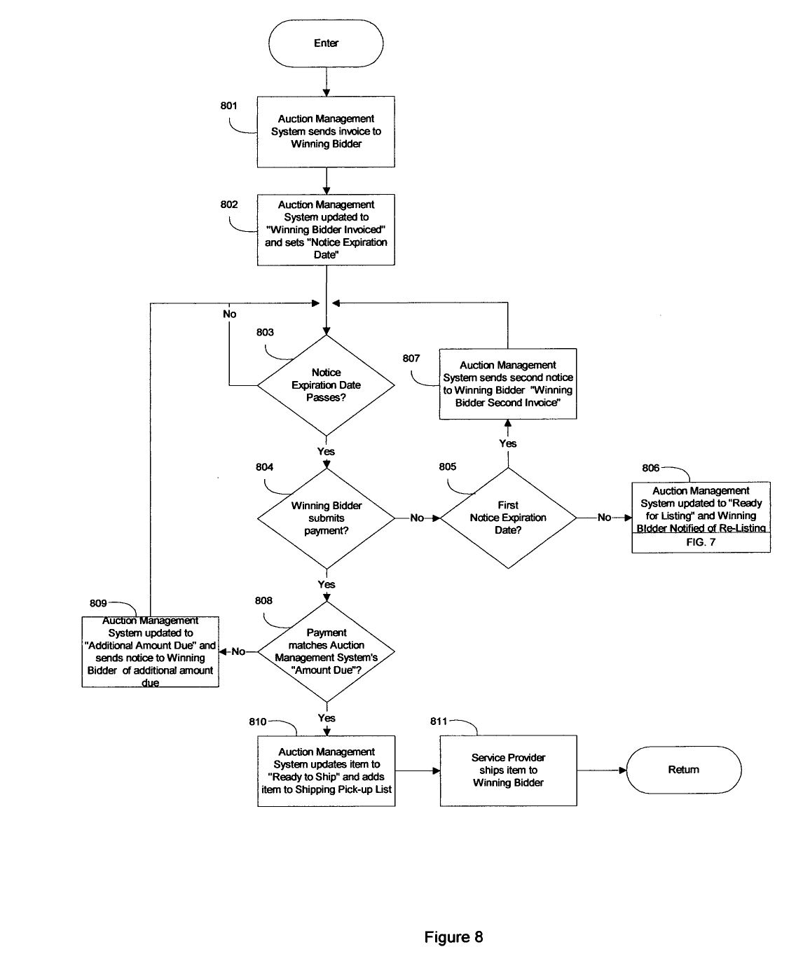

Thereafter, the posted goods are auctioned online item-by-item according to the respective accompanying notes, through the online auction provider's system (108, FIG. 1). If the item of interest is successfully sold on the online auction provider's website (109, FIG. 1), the service provider collects payment from the auction provider and ships the item to the winning bidder (111, FIG. 1). It will be recognized that many different auction processes may be invoked by an online auction provider without departing from the scope of the present invention. One such process is illustrated in the flow diagram of FIG. 8 (801-811), for the sake of example only.

For each item successfully auctioned through the online auction provider, an invoice is generated by the AMS and e-mailed to the winning bidder (801). The AMS then updates the item record as “Winning Bidder Invoiced” and sets a “Notice Expiration Date” (802), typically 3 business days from the date of the invoice but the Web Auction Specialist may override and set a longer or shorter period if appropriate. If the AMS determines that the expiration date has passed without receipt of payment from the winning bidder (803, 804), a check is performed as to whether the notice was a first notice (805), and if so, a second notice is sent to the winning bidder, the AMS item record is updated to “Winning Bidder Second Invoice” (807), and steps 803-805 are repeated with the newly set expiration date.

If no payment is received by the new expiration date, the current auction is nullified, the winning bidder is notified that the item will be re-listed and the item is re-listed as “Ready for Auction,” (806), with a return to the process illustrated in FIG. 7.

On the other hand, if payment is received from the winning bidder by the expiration date (either first or second), the AMS compares the payment amount with the Amount Due (808). If less than the amount due for the item, the AMS notifies the winning bidder of the deficiency and updates the record to “Additional Amount Due” (809), and the process returns to steps 803-808. If the received payment (including an additional payment in response to notice of a deficiency) matches the amount due for the item, the AMS updates the item record to “Ready to Ship” and adds it to a Shipping Pick-up List (810). A specialist prints the latter list from the AMS for packaging and labeling the listed items for shipment to the respective winning bidders (811).

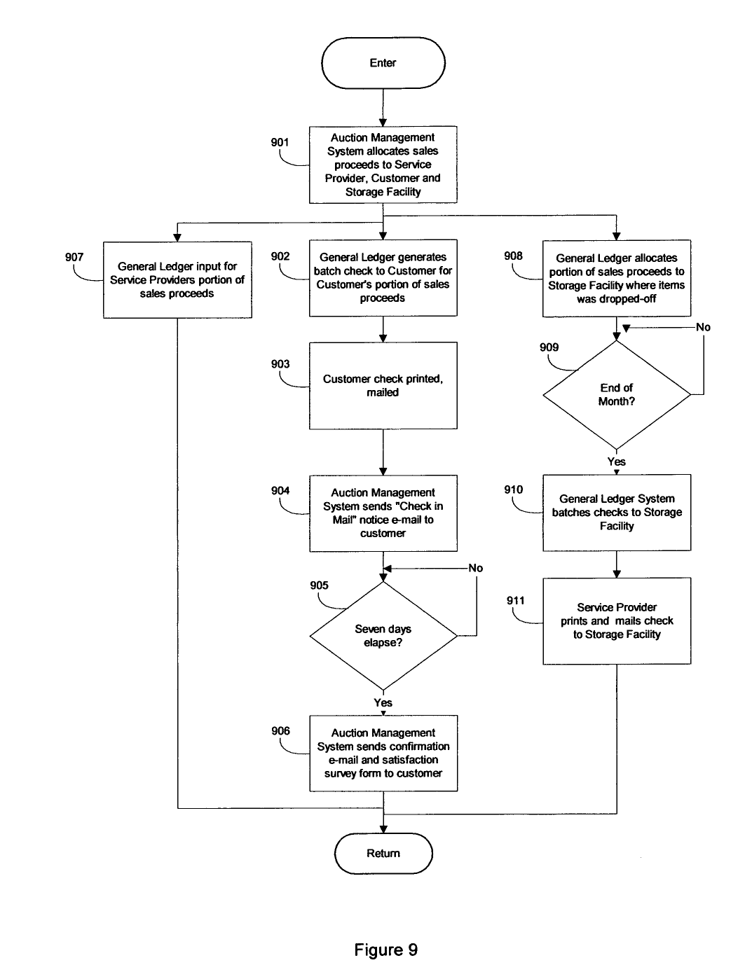

The proceeds of the successful sale are recognized on the books of the service provider, and disbursements from those proceeds are made to the storage facility and the customer by allocation through the AMS according to their respective agreed-upon shares (112, FIG. 1). An illustrative process for doing so is shown in the flow diagram of FIG. 9 (901-911), by way of example.

Referring to FIG. 9, the AMS allocates sales proceeds for an item sold on the online auction provider's web site, assigning funds to the service provider, the drop-off customer, and the receiving storage facility, by shares according to the respective agreements (901). Each category of funds is processed through the General Ledger System (GLS) (902, 907, 908). The GLS generates batch payments to the respective customers identified by the AMS as having items sold at auction in the period covered by the disbursements. For customers having had more than one item sold during the period of interest, the GLS combines the allocations for all of their respective sales into a single check per customer, and in any event the customer checks for that period are then printed and mailed (903). If appropriate for any given customer, the allocated funds may be disbursed by wire transfer to the customer's bank account. In either case, the AMS e-mails a notice of payment and of specific item(s) sold, to each affected customer (904). At the end of seven days from date of disbursement of payment, the AMS sends a confirmation and a customer satisfaction survey by e-mail to each customer (905, 906).

At the end of each month (909), the GLS processes payment to each storage facility that has been allocated finds in step 908, by batching checks to the respective facilities, printing and mailing the checks (or wire transferring the allocated finds to the storage facility's bank account) (910, 911).

In the event of an unsuccessfully attempted sale by auction, the follow-up handling of the item of interest depends on instructions previously given by the service provider's customer who dropped-off those goods (or the storage facility that supplied the liquidation goods, if applicable). The customer has either elected to re-list or not re-list the item for auction (110, FIG. 1). By default, according to a preferred method of the present invention, the item is automatically re-listed for auction unless the customer has expressly instructed otherwise. Whether by instruction or default, a re-listing of the item results in a return to step 107 in the flow diagram of FIG. 1, in which the Web Auction Specialist once again prepares the item for auction.

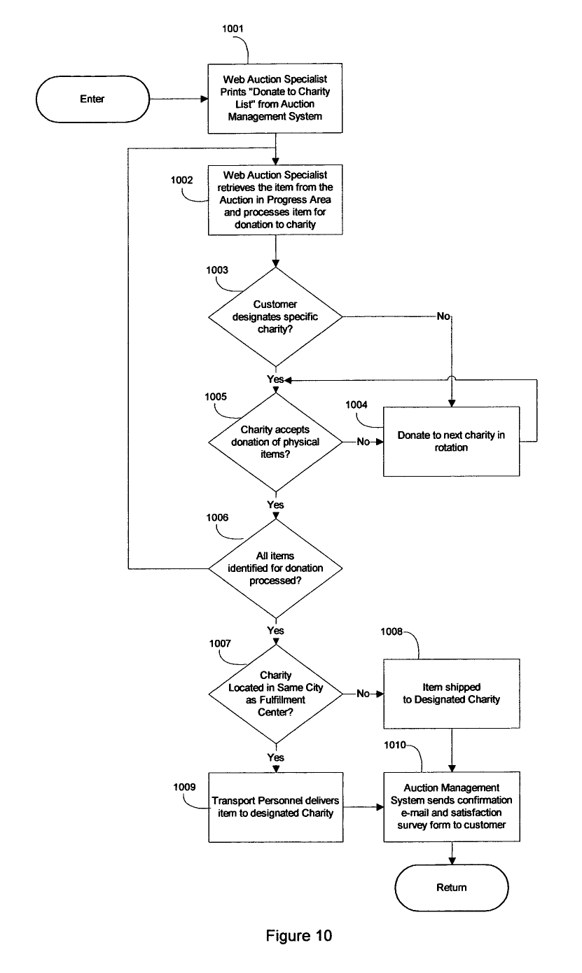

If the customer has elected not to re-list the item, its handling depends on whether the customer has instructed (by previous expression in the elected options section of the written agreement) that the item be returned to the customer or be donated to a charitable organization (113, FIG. 1). In the former case, the customer is notified to pick up the item from the service provider's fulfillment center (114, FIG. 1), thereby concluding the method of the present invention. If, however, a charitable donation has been elected by the customer, the item is donated in the name of the customer to the designated charity according to the exemplary process shown in the flow diagram of FIG. 10 (1001-1010), which concludes the invented method.

Referring to FIG. 10, a Web Auction Specialist prints a “Donate to Charity” list from the AMS (1001), indicating the name of a charity designated by the customer, or if no charity is designated, the next charity in rotation as listed in the AMS (1003, 1004). The specialist retrieves each item of goods on the “Donate to Charity” list and processes the item for donation as indicated (1002). If the designated charity fails o accept the item, it is donated to the next charity in the rotation, and so forth (1004, 1005). When all items on the “Donate to Charity” list for the period of interest have been processed for donation, the items are delivered by means according to the city of destination of the charity (1007, 1008, 1009). Thereafter, the AMS is updated accordingly, and notice of the donation is e-mailed to the customer along with a customer satisfaction survey form (1010).

Of course, as more storage facilities are constructed in an area of interest to the service provider additional contractual relationships may be entered into for added convenience of drop-off points to prospective customers.

FIG. 11 is a flow diagram illustrating the manner in which exceptions report items (505, FIG. 5; 606, FIG. 6) are handled. Reasons for inclusion of an item in an exceptions report, beyond missing items, include lack of a basis to establish a price for the item; a need for the item to be sold with one or more other items not yet available; shipping problems such as export issues, bulky item, or excess weight; a jewelry item or other item awaiting appraisal; etc. After the auction, items for which exceptions exist may include invalid shipping address or inability to secure payment for the item. It will be observed that other exceptions may arise and be handled at various stages of the method of the invention beyond those mentioned above.

Referring to FIG. 11, the exception item(s) is logged into the AMS (1101), and an Item Exception Report is generated (1102). A service provider manager then seeks to resolve each of exceptions (1103). If the exception is resolved, the AMS is updated accordingly, and the item that had been tagged as an exception is delivered to the Auction Prep Area (1104, 1105). Otherwise, further efforts are expended in an effort to finally resolve the exception and place the designated item in the Auction Prep Area.

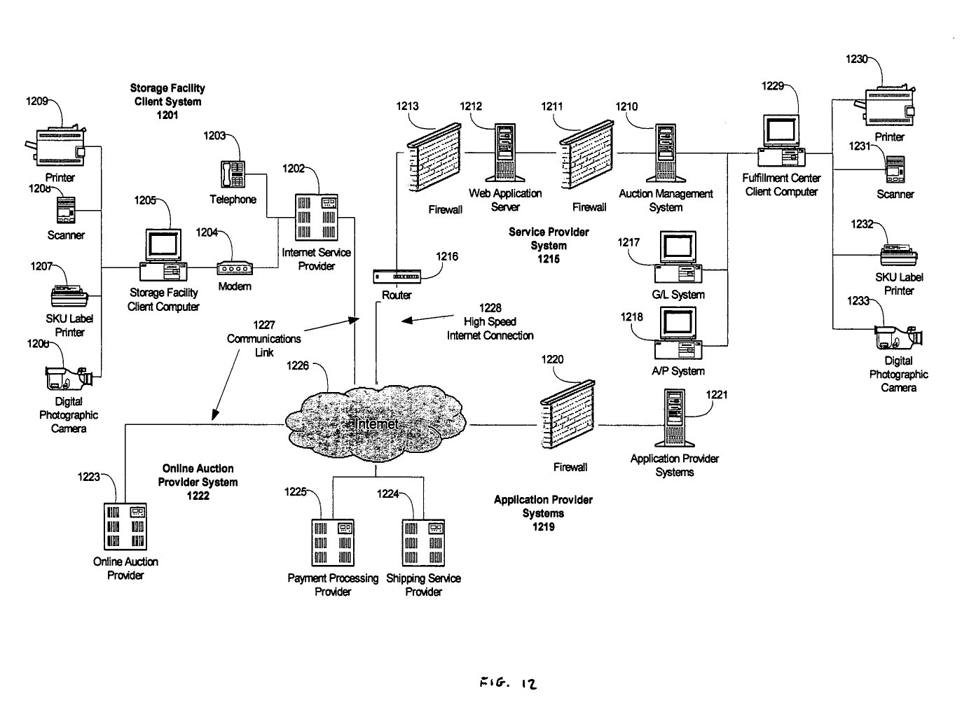

FIG. 12 illustrates an embodiment of a system for Internet auctioning of goods dropped off by the general public or selected for liquidation at storage facilities, according to the present invention.

A Storage Facility Client System 1201 accesses the functionality of the system through a web site hosted by Service Provider System 1215. Only one Storage Facility Client System 1201 is shown in FIG. 12 for the sake of simplicity, but it will be understood that, in practice, a large plurality of public storage facilities would exist in the geographical area of interest and be used by the service provider for accessing the interface of its System. A multiplicity of other Storage Facility Client Systems 1201 are contemplated by the present invention to exist in different cities and counties of different states across the country and locations around the world.

Storage Facility Client Computer 1205 is connected via Modem 1204 and Phone Connection 1203 to an Internet Service Provider 1202, which, in turn, gives Storage Facility Client Computer 1205 access to the Internet 1226 via a Communications Link 1227. Modem 1204, which typically provides 56K modem access, may be an external modem as shown, or an internal modem within the Storage Facility Client Computer 1205. Communications Link 1227 may be standard telephone line, a T-1 line or higher, a DS-1 line or higher, cable Internet access, or any other suitable communication link, and may provide considerably higher speed access. A telephone is also connected to Phone Connection 1203 and Modem 1204.

Printer 1209, which is connected to Storage Facility Client Computer 1205, may be used to print out various forms, pick-up lists, packing slips, and shipping manifests. SKU Label Printer 1207 also connected to Storage Facility Client Computer 1205, may be used to print out SKU bar code labels and shipping labels. Scanner 1208 may be used to scan the SKU bar code number into a SKU field for data entry. In the presently preferred embodiment, Scanner 1208 is connected to Storage Facility Client Computer 1205 through a Universal Serial Bus (USB) or Firewire connection. Digital Photographic Camera 1206 is used to photograph the items of goods to be auctioned, and preferably is also connected to Storage Facility Client Computer 1205 through a USB or Firewire connection.

The web site and also the inventory database accessed by Storage Facility Client Computer 1205 is provided by Service Provider System 1215. Router 1216 handles the traffic from the various Storage Facility Client Systems 1201 over Communications Link 1227. Firewall 1213 provides security for Web Application Server 1212, and firewall 1211 provides security for Auction Management System 1210, which houses the inventory database and the registration database.

In a presently preferred embodiment, Application Service Provider Systems 1219 provide the accounting functions necessary for the system of Internet auctioning of goods dropped off by the general public at the public storage facilities (1201 and others, not shown). One such application service provider of accounting packages for client/server environments is NetSuites, which may be connected to the Internet by a High-Speed Internet Connection 1228, typically DSL or T-1. Auction Management System 1210 connects behind Firewall 1211 to the A/P System 1218 and G/L System 1217.

Service Provider System 1215 provides management functions for the system of the invention. Router 1216 handles the traffic from Application Provider System 1219, Service Provider System 1215, and from other sources over High-Speed Internet Connection 1228.

Online Auction Provider 1223 (e.g., eBay) utilizes Encrypted Communication Link 1227 to send and receive information over the Internet, and receives information on items to be auctioned from Service Provider System 1215. Items are auctioned online by Online Auction Provider 1223, which sends the auction results to Service Provider System 1215.

Payment Processing 1225 (e.g., Paypal) also utilizes Encrypted Communication Link 1227, to receive batch files in real-time containing payment types and data from Service Provider System 1215, processes the payment types and data, and returns the results to Service Provider System 1215.

Shipping Service 1224 sends information such as tracking numbers over Communications Link 1227 to Service Provider System 1215, and receives information such as shipping manifests from the latter's inventory database. Shipping Service 1224 may be a common carrier such as Federal Express or United Parcel Service.

Although a presently contemplated best mode of practicing the invention has been disclosed herein by reference to a preferred method and system, it will be apparent to those skilled in the art from a consideration of the foregoing description that variations and modifications may be made without departing from the spirit and scope of the invention. Accordingly, it is intended that the invention be limited only by the appended claims and the rules and principles of applicable law.

1. A method of processing goods by a service provider for auction by an online auction house, comprising:
providing a multiplicity of sites within a designated limited geographical area for customer drop-off of goods desired to be sold at online auction, wherein each site consists of a pre-existing free-standing multi-unit public storage facility in said geographical area available to the general public for individual unit monthly rental;
inspecting goods dropped off at each respective site to assess acceptability for online auction; and
uniquely identifying each of the acceptable dropped-off goods for placement in a queue for auction by said online auction house.

2. The method of claim 1, wherein:
said inspecting of the dropped-off goods is performed at the respective drop-off site to assess acceptability of the goods for online auction.

3. The method of claim 2, wherein:
said inspecting of the dropped-off goods is performed by a service provider specialist at a designated central location of the service provider in said geographical area through a connection between said central location and the respective drop-off site.

4. The method of claim 1, including:
removing the uniquely identified dropped-off goods to a designated central location in said geographical area for placement in said auction queue.

5. The method of claim 1, including:
processing goods designated for liquidation from foreclosed third party units at each storage facility site to assess their acceptability for online auction, and
uniquely identifying each of the accepted liquidation goods along with dropped-off goods for placement in said auction queue.

6. The method of claim 5, including:
removing the uniquely identified dropped-off goods along with said uniquely identified dropped-off goods to a designated central location in said geographical area for placement in said auction queue.

7. The method of claim 1, including:
initially processing the dropped-off goods at the drop-off site by personnel of the respective public storage facility.

8. A system for processing goods for auction by an online auction house, comprising:
a multiplicity of sites within a designated limited geographical area for customer drop-off of goods desired to be sold at online auction, wherein each site consists of a pre-existing free-standing multi-unit public storage facility in said geographical area available to the general public for individual unit monthly rental;
means for processing the dropped-off goods to assess their acceptability for online auction; and
means for uniquely identifying each of the accepted dropped-off goods for placement in a queue for auction by said online auction house.

9. The system of claim 8, wherein:
said means for processing the dropped-off goods performs its function at the respective drop-off site to assess acceptability of the goods for online auction.

10. The system of claim 8, including:
means for transporting the uniquely identified dropped-off goods to a designated central location in said geographical area for placement in said auction queue.

11. The system of claim 8, wherein:
said means for processing is further adapted to process goods designated for liquidation from foreclosed third party units at each storage facility site to assess their acceptability for online auction, and
said means for uniquely identifying is further adapted to uniquely identify each of the accepted liquidation goods along with dropped-off goods for placement in said auction queue.

12. The system of claim 11, including:
means for transporting the uniquely identified dropped-off goods along with said uniquely identified dropped-off goods to a designated central location in said geographical area for placement in said auction queue.
